(19) United States
(12) Patent Application Publication
(10) Pub. No.: US 2025/0097633 A1
(43) Pub. Date: Mar. 20, 2025

(54) Playback Device with Acoustic Volume Coupling Vent

(71) Applicant: Sonos, Inc., Goleta, CA (US)

(72) Inventor: Edwin Johnson, Hopkinton, MA (US)

(21) Appl. No.: 18/887,494

(22) Filed: Sep. 17, 2024

Related U.S. Application Data
(60) Provisional application No. 63/583,491, filed on Sep. 18, 2023.

(51) Int. Cl. H04R 1/28; H04R 1/02; H04R 1/08; H04R 29/00

(52) U.S. Cl. CPC H04R 1/2811; H04R 1/025; H04R 1/08; H04R 29/001

(57) ABSTRACT

A playback device includes (i) at least one first transducer, (ii) at least one second transducer, (iii) a housing, and (iv) an acoustic resistive mesh filter. The housing includes (i) a first cavity having a first volume, the first cavity housing the at least one first transducer, (ii) a second cavity having a second volume, the second cavity in fluid communication with the at least one second transducer, and (iii) a vent fluidly coupling the first cavity and the second cavity, the vent defining an aperture having an open area. The acoustic resistive mesh filter is coupled to the vent and positioned to cover the open area of the aperture and thereby resist acoustic flow through the vent.

### CROSS-REFERENCE TO RELATED APPLICATIONS

This application claims priority to U.S. Provisional Application No. 63/583,491, filed Sep. 18, 2023, and titled “Playback Device with Acoustic Volume Coupling Vent,” the contents of which are incorporated herein by reference in their entirety.

### FIELD OF THE DISCLOSURE

The present disclosure is related to consumer goods and, more particularly, to portable playback devices that may be subject to the elements, such as playback devices for the purpose of media playback.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. In addition, Sonos has continued to innovate around ways to physically incorporate playback devices into a listening environment, including innovations around playback device size, shape, configuration, and placement.

Given the ever-growing interest in digital media, there continues to be a need to develop consumer-accessible technologies to further enhance the listening experience.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 1C is a block diagram of an example playback device.

FIG. 1D is a block diagram of an example playback device.

FIG. 1E is a block diagram of an example playback device.

FIG. 1F is a block diagram of an example network microphone device.

FIG. 1G is a block diagram of an example playback device.

FIG. 1H is a partially schematic diagram of an example control device.

FIG. 1I is a schematic diagram of example user interfaces of the example control device of FIG. 1H.

FIGS. 1J through 1M are schematic diagrams of example media playback system zones.

FIG. 1N is a schematic diagram of example media playback system areas.

FIG. 2 is a diagram of an example headset assembly for an example playback device.

FIG. 3 is an isometric diagram of an example playback device housing.

FIG. 4A is an isometric diagram of another example playback device and housing thereof.

FIG. 4B is an isometric diagram of a cutaway portion of the playback device of FIG. 4A.

FIG. 5A is a first cross-sectional view of the example playback device of FIG. 4A.

FIG. 5B is a second cross-sectional view of a portion of the example playback device of FIGS. 4-5A.

FIG. 5C is an isometric diagram of the example playback device of FIGS. 4-5B, shown with a top surface removed.

FIG. 5D is another isometric diagram of the example playback device of FIGS. 4-5C, illustrated similarly to the diagram of FIG. 5C, focused on an acoustic vent fluidly coupling the upper volume with a lower volume.

FIG. 5E is an isometric, cross-sectional diagram of the example playback device of FIGS. 4-5D, focused on the acoustic vent between two acoustic volumes.

FIG. 6 is a cross-sectional view of the acoustic vent of FIGS. 4-5E.

FIG. 7 is a flowchart showing example operations for manufacturing the example playback device of FIGS. 4-6.

FIG. 8 is a flowchart showing example operations for performing a pressure leak test of the playback device of FIGS. 4-7.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

Examples described herein involve playback devices that are designed to have significant resistance to liquid ingress. Such playback devices, which may include portable or battery powered playback devices, are desired particularly for portable and/or outdoor use. Due to the nature of use of a portable playback device, versus a “static” or stationary playback device (e.g., a device in a home theater setting), the portable playback device will, by virtue of its movability, have greater risk of being damaged by liquids or other substances.

To that end, many electronic devices, such as portable playback devices, are tested and rated for liquid ingress protection. Such devices may be tested and labeled in accordance with the ingress protection or “IP” code, as defined by the International Electrotechnical Commission (IEC) under the international standard IEC 60529. Accordingly, IEC 60529 classifies and provides a guideline to the degree of protection provided by mechanical housings and/or electrical enclosures against intrusion, dust, accidental contact, and water. IP codes aim to provide the consumer with more detailed information regarding the device's robustness to intrusion and/or its durability against the elements. This is in contrast to vague marketing terms like “water resistant” or “water proof,” which do not have a defined standard that can be trusted by a consumer.

An IP code includes, at least, two “digits” or fields that define a device's resistance to a broad form of element (e.g., a rating in a form of “IP [#][#]”). For example, the most significant digit may indicate a device's level of protection from solid particles (e.g., dust or other solid debris) and a second most significant digit may be indicative of a device's level of liquid or fluid ingress protection. In some examples, a third most significant digit is included to indicate a level of mechanical impact resistance for the tested device. If a manufacturer of a device does not or cannot indicate a level of one of these two or three categories, an “X” may be placed in that digit's field, indicating that no data is available to specify a protection rating about that digit's criterion.

While the innovations disclosed herein may be beneficial in improving upon satisfying IP code standards for one or both of solid particle ingress and mechanical impact resistance, the innovations disclosed herein are, generally, useful in satisfying or improving upon satisfying the liquid ingress IP code standards. Thus, the IP codes discussed herein, with respect to the technology herein, may take the form of “IPX[#],” as the solid particle ingress is not measured in testing, while the liquid ingress may have a value between 0 and 9. Meanings for each digit escalate on how well the device is protected from liquid, ranging from IPX0 (no protection against ingress of liquid), to IPX9 (powerful, high-temperature water jets). In between those extremes are a variety of liquid ingress protections that may be acceptable, given the device and its suggested use; examples include, but are not limited to including, IPX1 (dripping liquid), IPX3 (spraying liquid), IPX4 (splashings of liquid), IPX6 (powerful water jets) and IPX7 (immersion, up to 1 meter).

Separate from the IP code standards discussed above, many playback devices are pressure tested during production to determine whether there are any acoustic leaks in the playback device housing that might affect acoustic performance. This type of pressure testing often involves introducing a positive air pressure to cavities or chambers within the housing of the playback device and then monitoring how well the pressure is maintained over a period of time (e.g., measuring the rate at which the pressure drops). Beneficially, this same type of applied pressure test can also be helpful for determining whether the playback device is sufficiently sealed so as to be resistant to liquid ingress from its exterior.

Pressure testing of a playback device for acoustic performance and/or liquid ingress prevention may be complicated due to the specific cavities in the housing of the playback device and the specific configurations of said cavities. Cavities in playback devices often function as acoustic chambers, to enhance or facilitate the performance of a transducer (e.g., a microphone or a loudspeaker). For example, a cavity for a loudspeaker may be configured to acoustically focus or direct the output sound from the loudspeaker in a direction or multiple directions, whereas a cavity for a microphone may function as an acoustic chamber to trap ambient noise or direct noise from the environment, for converting into electrical signals for processing by the playback device or an associated system. Thus, playback devices may include multiple cavities within their housings, each having different uses and requiring separation of the cavities for proper acoustic functionality.

Generally, for a playback that includes both loudspeaker and microphone components, it is desirable to have a first cavity associated with the loudspeaker that is separate from (i.e., not in fluid communication with) a second cavity proximate to and/or associated with a microphone, thereby preventing acoustic leakage from the loudspeaker to the second cavity, which may reach the microphone. Thus, separate cavities may prevent a microphone from “hearing” or picking up unwanted noise or interference from the loudspeaker. In some examples, the cavity may not specifically be an acoustic volume but, rather, a cavity configured to be located underneath electronics, such as those disposed on a printed circuit board (PCB), for protection of the electronics and/or packages thereof (such as a microphone package). A cavity configured for protection of electronics, thus, may need pressure testing, to ensure proper functionality.

However, multiple separate cavities in a playback device complicates the testing process for determining the IP code or fluid ingress protection performance of the playback device, because both cavities may be susceptible to fluid ingress and, thus, both cavities may benefit from pressure testing. Testing of multiple cavities introduces greater cost for manufacturing and/or testing and, ultimately, increases cost for the manufacturer due to the increased manufacturing complexity. Further complicating the matter, some cavities functioning as acoustic volumes for playback device microphones may be quite small, thus limiting the practical dimensions for a port or other entrance for use in pressure testing. For these and other reasons, pressure testing of said small cavities, alone, may be difficult, impractical, or even impossible. Thus, testing to identify any potential leaks in the smaller, microphone-associated cavity are only able to be diagnosed by visual or physical inspection, neither of which is particularly reliable, time efficient, or practical during mass production of playback devices.

One potential solution to the pressure testing issues noted above is to fluidly couple the first and second chambers, by designing the housing with a vent therebetween, such that pressure testing can be performed in both chambers simultaneously, via pressure input in the first cavity only. Under this approach, any leakage associated with the second cavity could be identified during testing via pressure input to the first cavity. However, adding such a vent between the two cavities may give rise to new issues, as mentioned above, that can be associated with fluid communication between the first and second cavities. In some examples, such a vent may facilitate creation of a resonance with the vent and the upper cavity, which may create an unwanted impedance loading to the transducer associated with the first cavity. Additionally or alternatively, the acoustic pressure in the lower cavity, during standard use of the device, may partially enter into the second cavity, which can result in considerable self-sound recovered energy in the microphone of the second cavity.

Further still, for proper testing, any vent or hole connecting the two cavities must be manufactured to maintain a valid pressure leak path during the pressure leak test-meaning it must have sufficient size and fluid communicability for the pressure leak test. However, while it may be possible to form such a vent or hole with a size sufficiently small to prevent the self-sound and loading issues, while large enough to facilitate fluid testing, the machining or manufacturability of such a vent or hole may be impractical. Such hole sizes may simply be too small to be moldable during production of the housing and/or may be too small for practical micro-drilling of such a hole, using manufacturing capabilities that are currently available.

In some examples, pressure testing for a device may comprise a leak test method, which is a pressure decay test, wherein a pressure change is measured over time, for a given volume, to determine pressure leak characteristics. Alternatively, in some examples, pressure testing for a device may comprise utilizing a flow meter to measure a steady state leak rate of a pressurized volume, as a pressure input to the volume is maintained at a constant level.

To address these shortcomings, disclosed herein is technology for providing a vent between first and second cavities of a playback device to facilitate the simultaneous pressure testing of both cavities. However, in contrast with the aforementioned potential solution, the vents disclosed herein are operatively associated with acoustic resistive mesh filters. An “acoustic resistive mesh,” as defined herein, refers to a particular type of mesh material that is often used to achieve sound attenuation or noise suppression. In the context of noise suppression internal to a playback device, an acoustic resistive mesh may be utilized to divide portions of the device (or a cavity thereof), for the sake of acoustic isolation, while allowing some fluid communication between the divided portions. An acoustic resistive mesh filter may utilize such acoustic mesh materials by creating or selecting a mesh woven to a precise Rayl value, which is a measure of acoustic impedance or airflow resistance.

The particular characteristics of the mesh that is selected for a given playback device may depend on various factors, including the volumes of the first and/or second cavities that are divided by the vent, the area of the fluid opening between the cavities, the level of sound attenuation that is desired, among other possibilities. In some examples, the acoustic resistive mesh filter may be configured to have an acoustic impedance with a configured metre-kilogram-second (MKS) Rayl value tuned to the specific system; more specifically, in some certain examples, the acoustic mesh filter may be configured to have an acoustic impedance of about 3300 MKS Rayls. To that end, the MKS Rayl value is one factor that is used to tune the resistance of an acoustic mesh filter, as the acoustic Ohms of the exposed mesh area is configured as:

Ω=MKS Rayl/Area;

wherein Ω is the acoustic resistance, MKS Rayl is the MKS Rayl value tuned for the system, and Area is the open area of the acoustic mesh filter, in meters².

In some examples, the acoustic resistive mesh is configured to provide approximately 40 decibels (dB) of acoustic attenuation at a frequency of about 40 Hz. To achieve these filtering results, it may be advantageous to tune the acoustic mesh filter to form a first order low pass filter between the two cavities, such that if any acoustic self-sound occurs it may reside outside of the typical human range of hearing (e.g., between about 20 Hertz (Hz) and 20 kHz). That said, in some examples, the acoustic resistive mesh filter may be configured to operate as a low pass filter, having a −3 dB frequency of about 0.5 Hz. Thus, the acoustic resistive mesh filter has a very low cutoff frequency, for low pass filtering, but still provides enough of a pressure leak path, such that the pressure leak testing can still be performed, but the acoustic resistive mesh filter prevents self-sound between the two cavities. Accordingly, an acoustic resistive mesh filter designed with the aforementioned low pass characteristics may result in the 40 dB of acoustic attenuation at 40 Hz, which may be a lower limit at which a loudspeaker in the first cavity is driven.

By utilizing acoustic resistive mesh filters, the aforementioned acoustic and/or feedback issues that may be associated with the use of a vent can be mitigated, while allowing the vent to have an aperture of sufficient diameter or size, for ease of manufacture. Such a diameter for the aperture may be in a range of about 1 millimeter (mm) to about 5 mm; in some such examples, the diameter of the aperture is about 2 mm. Thus, with the acoustic resistive mesh filter included, the mesh can be placed between the two cavities to provide a valid pressure leak path for the production testing, yet still provide acoustic attenuation to mitigate the acoustics issues introduced by inclusion of a vent. Thus, by utilizing the acoustic resistive mesh filtering techniques and apparatus disclosed herein, manufacturing of playback devices and/or testing thereof may be simplified, leading to lower production time, cost savings, reduction in complexity of manufacturing procedures, among other benefits.

As indicated above, the examples herein involve a vent positioned between cavities of a playback device, that allow for simplified testing and manufacturability. In one aspect a playback device is provided that includes (i) at least one first transducer, (ii) at least one second transducer, (iii) a housing, and (iv) an acoustic resistive mesh filter. The housing includes (i) a first cavity having a first volume, the first cavity housing the at least one first transducer, (ii) a second cavity having a second volume, the second cavity in fluid communication with the at least one second transducer, and (iii) a vent fluidly coupling the first cavity and the second cavity, the vent defining an aperture having an open area. The acoustic resistive mesh filter is coupled to the vent and positioned to cover the open area of the aperture and thereby resist acoustic flow through the vent.

In another aspect, a method of performing a pressure leak test of a playback device is provided. The playback device includes (i) at least one first transducer, (ii) at least one second transducer, (iii) a housing, and (iv) an acoustic resistive mesh filter. The housing includes (i) a first cavity having a first volume, the first cavity housing the at least one first transducer, (ii) a second cavity having a second volume, the second cavity in fluid communication with the at least one second transducer, and (iii) a vent fluidly coupling the first cavity and the second cavity, the vent defining an aperture having an open area. The acoustic resistive mesh filter is coupled to the vent and positioned to cover the open area of the aperture and thereby resist acoustic flow through the vent. The method includes (i) introducing, via an input valve of the first cavity, a positive air pressure into the first cavity of the housing over a period of time such that the positive air pressure extends into the second cavity via the vent, and (ii) measuring an air pressure within the first cavity over the period of time.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

Moreover, some functions are described herein as being performed “based on” or “in response to” another element or function. “Based on” should be understood that one element or function is related to another function or element. “In response to” should be understood that one element or function is a necessary result of another function or element. For the sake of brevity, functions are generally described as being based on another function when a functional link exists; however, such disclosure should be understood as disclosing either type of functional relationship.

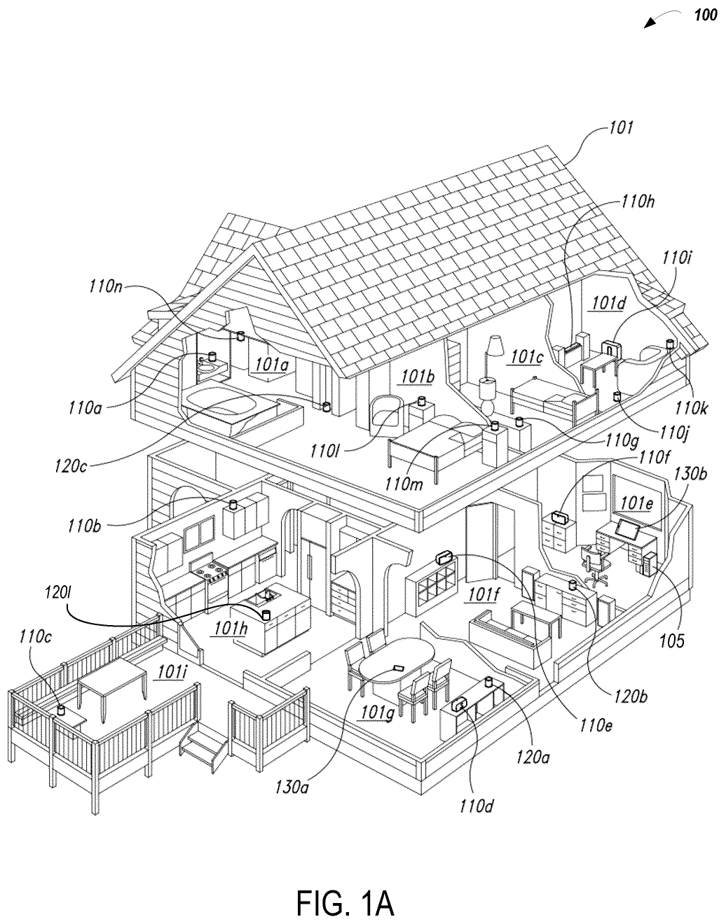

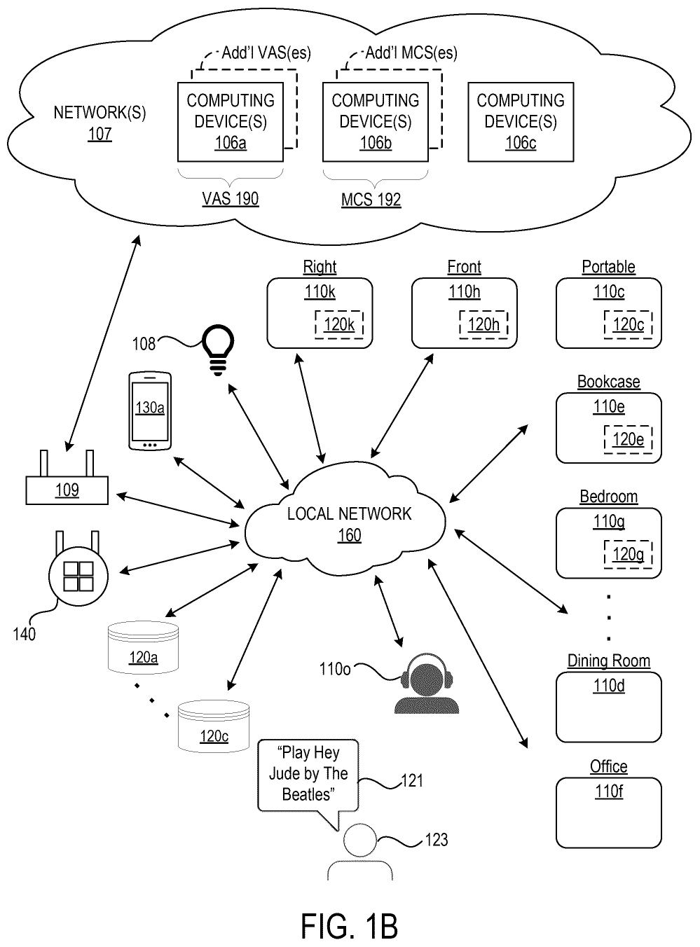

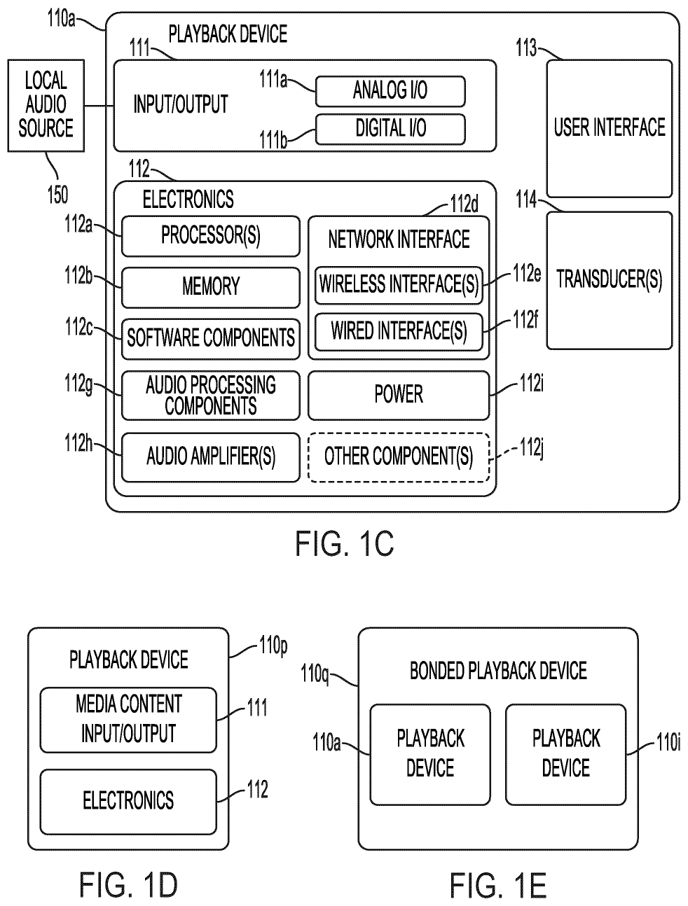

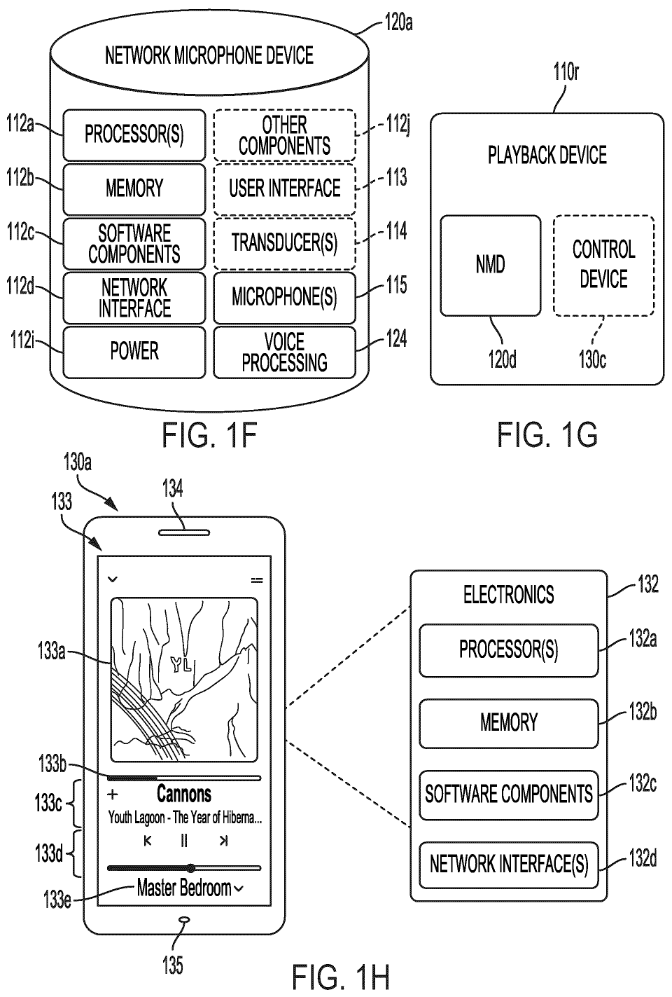

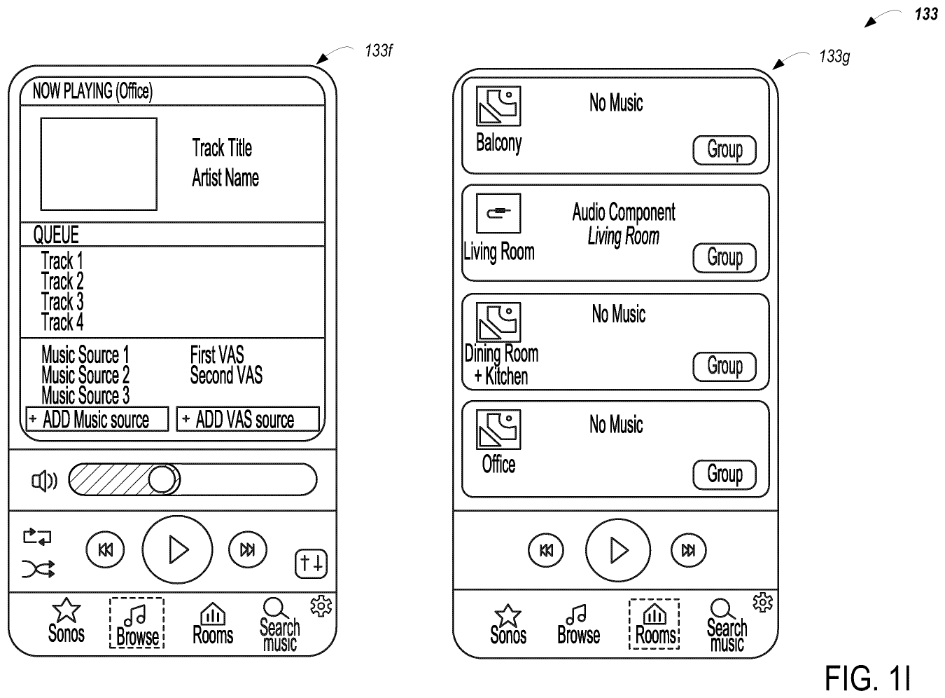

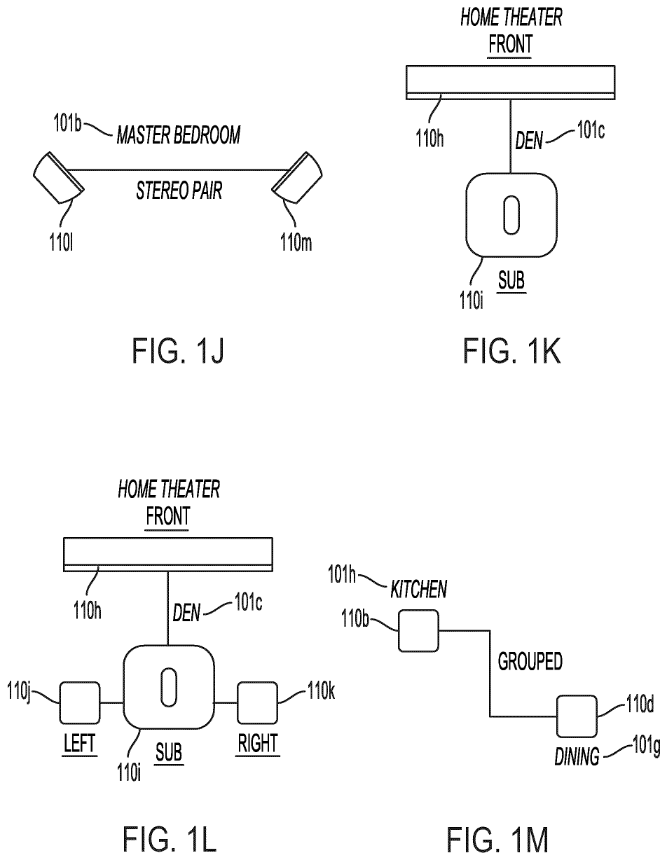

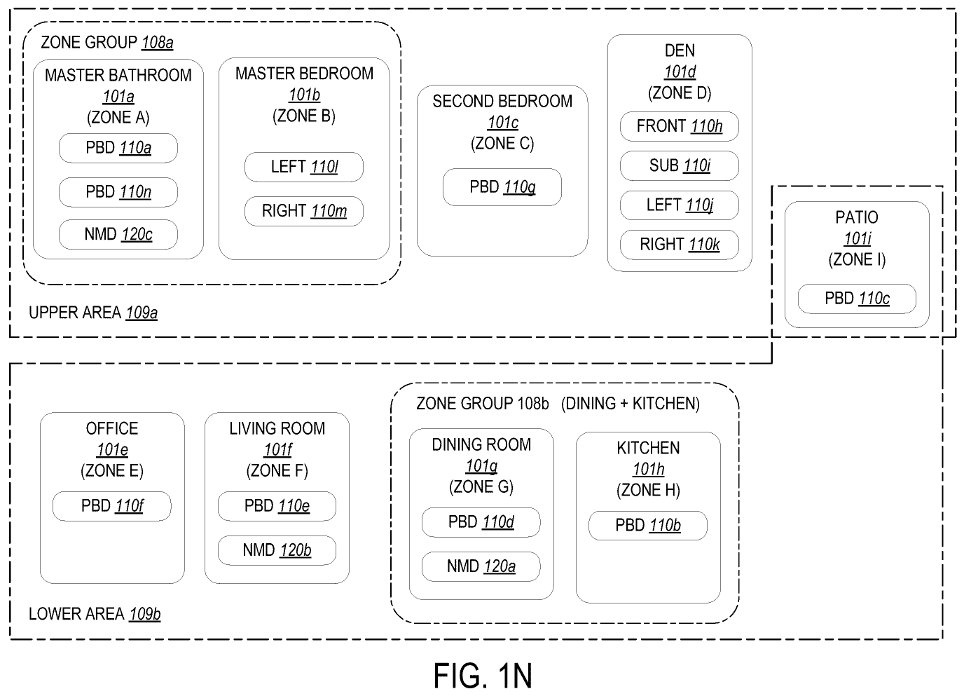

In the figures, identical reference numbers identify generally similar, and/or identical, elements. To facilitate the discussion of any particular element, the most significant digit or digits of a reference number refers to the figure in which that element is first introduced. For example, element 110a is first introduced and discussed with reference to FIG. 1A. Many of the details, dimensions, angles and other features shown in the figures are merely illustrative of particular embodiments of the disclosed technology. Accordingly, other embodiments can have other details, dimensions, angles and features without departing from the spirit or scope of the disclosure. In addition, those of ordinary skill in the art will appreciate that further embodiments of the various disclosed technologies can be practiced without several of the details described below.

### II. Suitable Operating Environment

a. Suitable Media Playback System

FIGS. 1A and 1B illustrate an example configuration of a media playback system (“MPS”) 100 in which one or more embodiments disclosed herein may be implemented. Referring first to FIG. 1A, a partial cutaway view of MPS 100 distributed in an environment 101 (e.g., a house) is shown. The MPS 100 as shown is associated with an example home environment having a plurality of rooms and spaces. The MPS 100 comprises one or more playback devices 110 (identified individually as playback devices 110a-o), one or more network microphone devices (“NMDs”) 120 (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term NMD (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the MPS 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the MPS 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some embodiments, for example, the MPS 100 is configured to play back audio from a first playback device (e.g., the playback device 110a) in synchrony with a second playback device (e.g., the playback device 110b). Interactions between the playback devices 110, NMDs 120, and/or control devices 130 of the MPS 100 configured in accordance with the various embodiments of the disclosure are described in greater detail below with respect to FIGS. 1B-IN.

In the illustrated embodiment of FIG. 1A, the environment 101 comprises a household having several rooms, spaces, and/or playback zones, including (clockwise from upper left) a Master Bathroom 101a, a Master Bedroom 101b, a Second Bedroom 101c, a Family Room or Den 101d, an Office 101e, a Living Room 101f, a Dining Room 101g, a Kitchen 101h, and an outdoor Patio 101i. While certain embodiments and examples are described below in the context of a home environment, the technologies described herein may be implemented in other types of environments. In some embodiments, for example, the MPS 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The MPS 100 can comprise one or more playback zones, some of which may correspond to the rooms in the environment 101. The MPS 100 can be established with one or more playback zones, after which additional zones may be added and/or removed to form, for example, the configuration shown in FIG. 1A. Each zone may be given a name according to a different room or space such as the Office 101e, Master Bathroom 101a, Master Bedroom 101b, the Second Bedroom 101c, Kitchen 101h, Dining Room 101g, Living Room 101f, and/or the Patio 101i. In some aspects, a single playback zone may include multiple rooms or spaces. In certain aspects, a single room or space may include multiple playback zones.

In the illustrated embodiment of FIG. 1A, the Master Bathroom 101a, the Second Bedroom 101c, the Office 101e, the Living Room 101f, the Dining Room 101g, the Kitchen 101h, and the outdoor Patio 101i each include one playback device 110, and the Master Bedroom 101b and the Den 101d include a plurality of playback devices 110. In the Master Bedroom 101b, the playback devices 110l and 110m may be configured, for example, to play back audio content in synchrony as individual ones of playback devices 110, as a bonded playback zone, as a consolidated playback device, and/or any combination thereof. Similarly, in the Den 101d, the playback devices 110h-j can be configured, for instance, to play back audio content in synchrony as individual ones of playback devices 110, as one or more bonded playback devices, and/or as one or more consolidated playback devices.

Referring to FIG. 1B, the home environment may include additional and/or other computing devices, including local network devices, such as one or more smart illumination devices 108 (FIG. 1B), a smart thermostat 140 (FIG. 1B), and a local computing device 105 (FIG. 1A). Numerous other examples of local network devices (not shown) are also possible, such as doorbells, cameras, smoke alarms, televisions, gaming consoles, garage door openers, etc. In embodiments described below, one or more of the various playback devices 110 may be configured as portable playback devices, while others may be configured as stationary playback devices. For example, the headphones 1100 (FIG. 1B) are a portable playback device, while the playback device 110e on the bookcase may be a stationary device. As another example, the playback device 110c on the Patio 101i may be a battery-powered device, which may allow it to be transported to various areas within the environment 101, and outside of the environment 101, when it is not plugged in to a wall outlet or the like.

With reference still to FIG. 1B, the various playback, network microphone, and controller devices and/or other network devices of the MPS 100 may be coupled to one another via point-to-point connections and/or over other connections, which may be wired and/or wireless, via a local network 160 that may include a network router 109. For example, the playback device 110j in the Den 101d (FIG. 1A), which may be designated as the “Left” device, may have a point-to-point connection with the playback device 110k, which is also in the Den 101d and may be designated as the “Right” device. In a related embodiment, the Left playback device 110j may communicate with other network devices, such as the playback device 110h, which may be designated as the “Front” device, via a point-to-point connection and/or other connections via the local network 160.

The local network 160 may be, for example, a network that interconnects one or more devices within a limited area (e.g., a residence, an office building, a car, an individual's workspace, etc.). The local network 160 may include, for example, one or more local area networks (LANs) such as a wireless local area network (WLAN) (e.g., a WIFI network, a Z-Wave network, etc.) and/or one or more personal area networks (PANs) (e.g. a BLUETOOTH network, a wireless USB network, a ZigBee network, an IRDA network, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WIFI” can refer to several different communication protocols including, for example, Institute of Electrical and Electronics Engineers (IEEE) 802.11a, 802.11b, 802.11g, 802.12, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHZ, 6 GHZ, and/or another suitable frequency.

The MPS 100 is configured to receive media content from the local network 160. The received media content can comprise, for example, a Uniform Resource Identifier (URI) and/or a Uniform Resource Locator (URL). For instance, in some examples, the MPS 100 can stream, download, or otherwise obtain data from a URI or a URL corresponding to the received media content.

As further shown in FIG. 1B, the MPS 100 may be coupled to one or more remote computing devices 106 via a wide area network (“WAN”) 107. In some embodiments, each remote computing device 106 may take the form of one or more cloud servers. The remote computing devices 106 may be configured to interact with computing devices in the environment 101 in various ways. For example, the remote computing devices 106 may be configured to facilitate streaming and/or controlling playback of media content, such as audio, in the environment 101 (FIG. 1A).

In some implementations, the various playback devices 110, NMDs 120, and/or control devices 130 may be communicatively coupled to at least one remote computing device associated with a voice assistant service (“VAS”) and/or at least one remote computing device associated with a media content service (“MCS”). For instance, in the illustrated example of FIG. 1B, remote computing devices 106a are associated with a VAS 190 and remote computing devices 106b are associated with an MCS 192. Although only a single VAS 190 and a single MCS 192 are shown in the example of FIG. 1B for purposes of clarity, the MPS 100 may be coupled to any number of different VASes and/or MCSes. In some embodiments, the various playback devices 110, NMDs 120, and/or control devices 130 may transmit data associated with a received voice input to a VAS configured to (i) process the received voice input data and (ii) transmit a corresponding command to the MPS 100. In some aspects, for example, the computing devices 106a may comprise one or more modules and/or servers of a VAS. In some implementations, VASes may be operated by one or more of SONOS®, AMAZON®, GOOGLE® APPLE®, MICROSOFT®, NUANCE®, or other voice assistant providers. In some implementations, MCSes may be operated by one or more of SPOTIFY®, PANDORA®, AMAZON MUSIC®, YOUTUBE MUSIC, APPLE MUSIC®, GOOGLE PLAY®, or other media content services.

In some embodiments, the local network 160 comprises a dedicated communication network that the MPS 100 uses to transmit messages between individual devices and/or to transmit media content to and from MCSes. In certain embodiments, the local network 160 is configured to be accessible only to devices in the MPS 100, thereby reducing interference and competition with other household devices. In other embodiments, however, the local network 160 comprises an existing household communication network (e.g., a household WIFI network). In some embodiments, the MPS 100 is implemented without the local network 160, and the various devices comprising the MPS 100 can communicate with each other, for example, via one or more direct connections, PANs, telecommunication networks (e.g., an LTE network or a 5G network, etc.), and/or other suitable communication links.

In some embodiments, audio content sources may be regularly added and/or removed from the MPS 100. In some embodiments, for example, the MPS 100 performs an indexing of media items when one or more media content sources are updated, added to, and/or removed from the MPS 100. The MPS 100 can scan identifiable media items in some or all folders and/or directories accessible to the various playback devices and generate or update a media content database comprising metadata (e.g., title, artist, album, track length) and other associated information (e.g., URIs, URLs) for each identifiable media item found. In some embodiments, for example, the media content database is stored on one or more of the various playback devices, network microphone devices, and/or control devices of MPS 100.

As further shown in FIG. 1B, the remote computing devices 106 further include remote computing device(s) 106c configured to perform certain operations, such as remotely facilitating media playback functions, managing device and system status information, directing communications between the devices of the MPS 100 and one or multiple VASes and/or MCSes, among other operations. In one example, the remote computing devices 106c provide cloud servers for one or more SONOS Wireless HiFi Systems.

In various implementations, one or more of the playback devices 110 may take the form of or include an on-board (e.g., integrated) network microphone device configured to detect sound, including voice utterances from a user. For example, the playback devices 110c-110h, and 110k include or are otherwise equipped with corresponding NMDs 120c-120h, and 120k, respectively. A playback device that includes or is equipped with an NMD may be referred to herein interchangeably as a playback device or an NMD unless indicated otherwise in the description. In some cases, one or more of the NMDs 120 may be a stand-alone device. For example, the NMD 1201 (FIG. 1A) may be a stand-alone device. A stand-alone NMD may omit components and/or functionality that is typically included in a playback device, such as a speaker or related electronics. For instance, in such cases, a stand-alone NMD may not produce audio output or may produce limited audio output (e.g., relatively low-quality audio output).

The various playback and network microphone devices 110 and 120 of the MPS 100 may each be associated with a unique name, which may be assigned to the respective devices by a user, such as during setup of one or more of these devices. For instance, as shown in the illustrated example of FIG. 1B, a user may assign the name “Bookcase” to playback device 110e because it is physically situated on a bookcase. Similarly, the NMD 1201 may be assigned the named “Island” because it is physically situated on an island countertop in the Kitchen 101h (FIG. 1A). Some playback devices may be assigned names according to a zone or room, such as the playback devices 110g, 110d, and 110f, which are named “Bedroom,” “Dining Room,” and “Office,” respectively. Further, certain playback devices may have functionally descriptive names. For example, the playback devices 110k and 110h are assigned the names “Right” and “Front,” respectively, because these two devices are configured to provide specific audio channels during media playback in the zone of the Den 101d (FIG. 1A). The playback device 110c in the Patio 101i may be named “Portable” because it is battery-powered and/or readily transportable to different areas of the environment 101. Other naming conventions are possible.

As discussed above, an NMD may detect and process sound from its environment, including audio output played by itself, played by other devices in the environment 101, and/or sound that includes background noise mixed with speech spoken by a person in the NMD's vicinity. For example, as sounds are detected by the NMD in the environment, the NMD may process the detected sound to determine if the sound includes speech that contains voice input intended for the NMD and ultimately a particular VAS. For example, the NMD may identify whether speech includes a wake word (also referred to herein as an activation word) associated with a particular VAS.

In the illustrated example of FIG. 1B, the NMDs 120 are configured to interact with the VAS 190 over the local network 160 and/or the router 109. Interactions with the VAS 190 may be initiated, for example, when an NMD identifies in the detected sound a potential wake word. The identification causes a wake-word event, which in turn causes the NMD to begin transmitting detected-sound data to the VAS 190. In some implementations, the various local network devices 105, 110, 120, and 130 (FIG. 1A) and/or remote computing devices 106c of the MPS 100 may exchange various feedback, information, instructions, and/or related data with the remote computing devices associated with the selected VAS. Such exchanges may be related to or independent of transmitted messages containing voice inputs. In some embodiments, the remote computing device(s) and the MPS 100 may exchange data via communication paths as described herein and/or using a metadata exchange channel as described in U.S. Pat. No. 10,499,146, issued Nov. 13, 2019 and titled “Voice Control of a Media Playback System,” which is herein incorporated by reference in its entirety.

Upon receiving the stream of sound data, the VAS 190 may determine if there is voice input in the streamed data from the NMD, and if so the VAS 190 may also determine an underlying intent in the voice input. The VAS 190 may next transmit a response back to the MPS 100, which can include transmitting the response directly to the NMD that caused the wake-word event. The response is typically based on the intent that the VAS 190 determined was present in the voice input. As an example, in response to the VAS 190 receiving a voice input with an utterance to “Play Hey Jude by The Beatles,” the VAS 190 may determine that the underlying intent of the voice input is to initiate playback and further determine that intent of the voice input is to play the particular song “Hey Jude” performed by The Beatles. After these determinations, the VAS 190 may transmit a command to a particular MCS 192 to retrieve content (i.e., the song “Hey Jude” by The Beatles), and that MCS 192, in turn, provides (e.g., streams) this content directly to the NIPS 100 or indirectly via the VAS 190. In some implementations, the VAS 190 may transmit to the NIPS 100 a command that causes the MPS 100 itself to retrieve the content from the MCS 192.

In certain implementations, NMDs may facilitate arbitration amongst one another when voice input is identified in speech detected by two or more NMDs located within proximity of one another. For example, the NMD-equipped playback device 110e in the environment 101 (FIG. 1A) is in relatively close proximity to the NMD-equipped Living Room playback device 120b, and both devices 110e and 120b may at least sometimes detect the same sound. In such cases, this may require arbitration as to which device is ultimately responsible for providing detected-sound data to the remote VAS. Examples of arbitrating between NMDs may be found, for example, in previously referenced U.S. Pat. No. 10,499,146.

In certain implementations, an NMD may be assigned to, or otherwise associated with, a designated or default playback device that may not include an NMD. For example, the Island NMD 1201 in the Kitchen 101h (FIG. 1A) may be assigned to the Dining Room playback device 110d, which is in relatively close proximity to the Island NMD 1201. In practice, an NMD may direct an assigned playback device to play audio in response to a remote VAS receiving a voice input from the NMD to play the audio, which the NMD might have sent to the VAS in response to a user speaking a command to play a certain song, album, playlist, etc. Additional details regarding assigning NMDs and playback devices as designated or default devices may be found, for example, in previously referenced U.S. Pat. No. 10,499,146.

Further aspects relating to the different components of the example MPS 100 and how the different components may interact to provide a user with a media experience may be found in the following sections. While discussions herein may generally refer to the example MPS 100, technologies described herein are not limited to applications within, among other things, the home environment described above. For instance, the technologies described herein may be useful in other home environment configurations comprising more or fewer of any of the playback devices 110, network microphone devices 120, and/or control devices 130. For example, the technologies herein may be utilized within an environment having a single playback device 110 and/or a single NMD 120. In some examples of such cases, the local network 160 (FIG. 1B) may be eliminated and the single playback device 110 and/or the single NMD 120 may communicate directly with the remote computing devices 106a-c. In some embodiments, a telecommunication network (e.g., an LTE network, a 5G network, etc.) may communicate with the various playback devices 110, network microphone devices 120, and/or control devices 130 independent of the local network 160.

b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises a High-Definition Multimedia Interface (HDMI) interface and/or cable. In some embodiments, the digital I/O 111b includes one or more wireless communication links comprising, for example, a radio frequency (RF), infrared, WIFI, BLUETOOTH, or another suitable communication protocol. In certain embodiments, the analog I/O 111a and the digital I/O 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 150 via the input/output 111 (e.g., a cable, a wire, a PAN, a BLUETOOTH connection, an ad hoc wired or wireless communication network, and/or another suitable communication link). The local audio source 150 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some aspects, the local audio source 150 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 150. In other embodiments, however, the media playback system omits the local audio source 150 altogether. In some embodiments, the playback device 110a does not include an input/output 111 and receives all audio content via the local network 160.

The playback device 110a further comprises electronics 112, a user interface 113 (e.g., one or more buttons, knobs, dials, touch-sensitive surfaces, displays, touchscreens), and one or more transducers 114 (e.g., a driver), referred to hereinafter as “the transducers 114.” The electronics 112 is configured to receive audio from an audio source (e.g., the local audio source 150) via the input/output 111, one or more of the computing devices 106a-c via the local network 160 (FIG. 1B), amplify the received audio, and output the amplified audio for playback via one or more of the transducers 114. In some embodiments, the playback device 110a optionally includes one or more microphones (e.g., a single microphone, a plurality of microphones, a microphone array) (hereinafter referred to as “the microphones”). In certain embodiments, for example, the playback device 110a having one or more of the optional microphones can operate as an NMD configured to receive voice input from a user and correspondingly perform one or more operations based on the received voice input, which will be discussed in more detail further below with respect to FIGS. 1F and 1G.

In the illustrated embodiment of FIG. 1C, the electronics 112 comprise one or more processors 112a (referred to hereinafter as “the processors 112a”), memory 112b, software components 112c, a network interface 112d, one or more audio processing components 112g, one or more audio amplifiers 112h (referred to hereinafter as “the amplifiers 112h”), and power components 112i (e.g., one or more power supplies, power cables, power receptacles, batteries, induction coils, Power-over Ethernet (POE) interfaces, and/or other suitable sources of electric power).

In some embodiments, the electronics 112 optionally include one or more other components 112j (e.g., one or more sensors, video displays, touchscreens, battery charging bases). In some embodiments, the playback device 110a and electronics 112 may further include one or more voice processing components that are operably coupled to one or more microphones, and other components as described below with reference to FIGS. 1F and 1G.

The processors 112a can comprise clock-driven computing component(s) configured to process data, and the memory 112b can comprise a computer-readable medium (e.g., a tangible, non-transitory computer-readable medium, data storage loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some embodiments, the operations further include causing the playback device 110a to send audio data to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices and/or zones can be found, for example, in U.S. Pat. No. 8,234,395 entitled “System and method for synchronizing operations among a plurality of independently clocked digital data processing devices,” which is herein incorporated by reference in its entirety.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the MPS 100. In some aspects, for example, the state data is shared during predetermined intervals of time (e.g., every 5 seconds, every 10 seconds, every 60 seconds) among at least a portion of the devices of the MPS 100, so that one or more of the devices have the most recent data associated with the MPS 100.

The network interface 112d is configured to facilitate a transmission of data between the playback device 110a and one or more other devices on a data network. The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the local network 160 (FIG. 1B) in accordance with a suitable wireless communication protocol (e.g., WIFI, BLUETOOTH, LTE). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 excludes the network interface 112d altogether and transmits and receives media content and/or other data via another communication path (e.g., the input/output 111).

The audio processing components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DAC), audio preprocessing components, audio enhancement components, digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omits the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 includes a single one of the amplifiers 112h configured to output amplified audio signals to a plurality of the transducers 114. In some other embodiments, the electronics 112 omits the amplifiers 112h.

In some implementations, the power components 112i of the playback device 110a may additionally include an internal power source (e.g., one or more batteries) configured to power the playback device 110a without a physical connection to an external power source. When equipped with the internal power source, the playback device 110a may operate independent of an external power source. In some such implementations, an external power source interface may be configured to facilitate charging the internal power source. As discussed before, a playback device comprising an internal power source may be referred to herein as a “portable playback device.” On the other hand, a playback device that operates using an external power source may be referred to herein as a “stationary playback device,” although such a device may in fact be moved around a home or other environment.

The user interface 113 may facilitate user interactions independent of or in conjunction with user interactions facilitated by one or more of the control devices 130 (FIG. 1A). In various embodiments, the user interface 113 includes one or more physical buttons and/or supports graphical interfaces provided on touch sensitive screen(s) and/or surface(s), among other possibilities, for a user to directly provide input. The user interface 113 may further include one or more light components (e.g., LEDs) and the speakers to provide visual and/or audio feedback to a user.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

In some embodiments, the playback device 110a may include a speaker interface for connecting the playback device to external speakers. In other embodiments, the playback device 110a may include an audio interface for connecting the playback device to an external audio amplifier or audio-visual receiver.

By way of illustration, SONOS, Inc. presently offers (or has offered) for sale certain playback devices including, for example, a “SONOS ONE,” “PLAY:1,” “PLAY:3,” “PLAY:5,” “PLAYBAR,” “PLAYBASE,” “CONNECT:AMP,” “CONNECT,” “SUB,” “BEAM,” “ARC,” “MOVE,” “ERA 100,” “ERA 300,” and “ROAM,” among others. Other suitable playback devices may additionally or alternatively be used to implement the playback devices of example embodiments disclosed herein. Additionally, one of ordinary skilled in the art will appreciate that a playback device is not limited to the examples described herein or to SONOS product offerings. In some embodiments, for example, one or more of the playback devices 110 may comprise a docking station and/or an interface configured to interact with a docking station for personal mobile media playback devices. In certain embodiments, a playback device may be integral to another device or component such as a television, a lighting fixture, or some other device for indoor or outdoor use. In some embodiments, a playback device may omit a user interface and/or one or more transducers. For example, FIG. 1D is a block diagram of a playback device 110p comprising the input/output 111 and electronics 112 without the user interface 113 or transducers 114.

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is full-range playback device configured to render low frequency, mid-range frequency, and high frequency audio content, and the playback device 110i is a subwoofer configured to render low frequency audio content. In some aspects, the playback device 110a, when bonded with playback device 110i, is configured to render only the mid-range and high frequency components of a particular audio content, while the playback device 110i renders the low frequency component of the particular audio content. In some embodiments, the bonded playback device 110q includes additional playback devices and/or another bonded playback device.

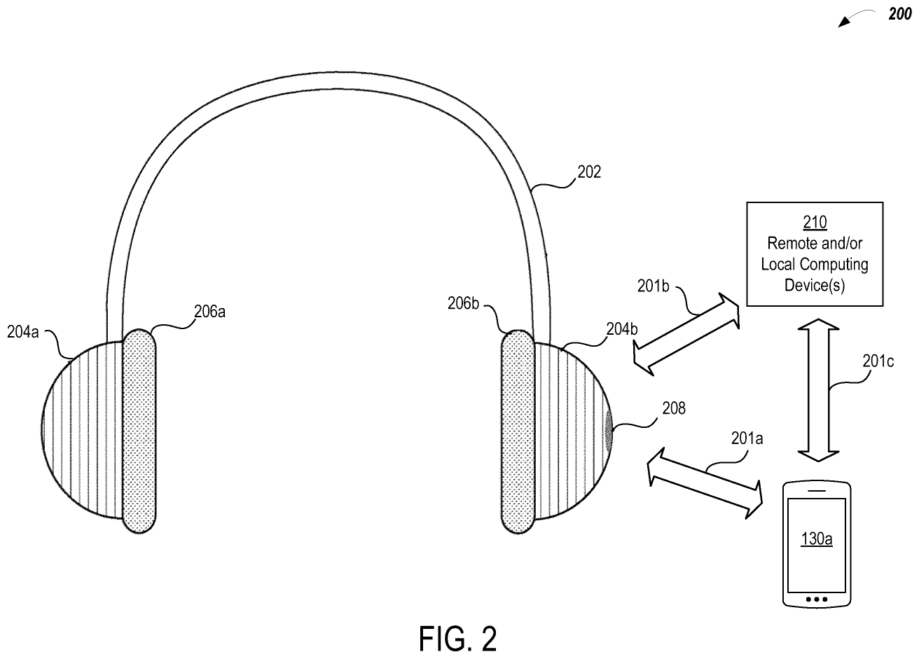

In some embodiments, one or more of the playback devices 110 may take the form of a wired and/or wireless headphone device (e.g., over-ear headphones, on-ear headphones, in-ear earphones, etc.). For instance, FIG. 2 shows an example headset assembly 200 (“headset 200”) for such an implementation of one of the playback devices 110. As shown, the headset 200 includes a headband 202 that couples a first earcup 204a to a second earcup 204b. Each of the earcups 204a and 204b may house any portion of the electronic components in the playback device 110, such as one or more speakers. Further, one or both of the earcups 204a and 204b may include a user interface for controlling audio playback, volume level, and other functions. The user interface may include any of a variety of control elements such as a physical button 208, a slider (not shown), a knob (not shown), and/or a touch control surface (not shown). As shown in FIG. 2, the headset 200 may further include ear cushions 206a and 206b that are coupled to earcups 204a and 204b, respectively. The ear cushions 206a and 206b may provide a soft barrier between the head of a user and the earcups 204a and 204b, respectively, to improve user comfort and/or provide acoustic isolation from the ambient (e.g., passive noise reduction (PNR)).

As described in greater detail below, the electronic components of a playback device may include one or more network interface components (not shown in FIG. 2) to facilitate wireless communication over one more communication links. For instance, a playback device may communicate over a first communication link 201a (e.g., a BLUETOOTH link) with one of the control devices 130, such as the control device 130a, and/or over a second communication link 201b (e.g., a WIFI or cellular link) with one or more other computing devices 210 (e.g., a network router and/or a remote server). As another possibility, a playback device may communicate over multiple communication links, such as the first communication link 201a with the control device 130a and a third communication link 201c (e.g., a WIFI or cellular link) between the control device 130a and the one or more other computing devices 210. Thus, the control device 130a may function as an intermediary between the playback device and the one or more other computing devices 210, in some embodiments.

In some instances, the headphone device may take the form of a hearable device. Hearable devices may include those headphone devices (including ear-level devices) that are configured to provide a hearing enhancement function while also supporting playback of media content (e.g., streaming media content from a user device over a PAN, streaming media content from a streaming music service provider over a WLAN and/or a cellular network connection, etc.). In some instances, a hearable device may be implemented as an in-ear headphone device that is configured to playback an amplified version of at least some sounds detected from an external environment (e.g., all sound, select sounds such as human speech, etc.)

It should be appreciated that one or more of the playback devices 110 may take the form of other wearable devices separate and apart from a headphone device. Wearable devices may include those devices configured to be worn about a portion of a user (e.g., a head, a neck, a torso, an arm, a wrist, a finger, a leg, an ankle, etc.). For example, the playback devices 110 may take the form of a pair of glasses including a frame front (e.g., configured to hold one or more lenses), a first temple rotatably coupled to the frame front, and a second temple rotatable coupled to the frame front. In this example, the pair of glasses may comprise one or more transducers integrated into at least one of the first and second temples and configured to project sound towards an ear of the subject.

c. Suitable Network Microphone Devices (NMDs)

FIG. 1F is a block diagram of the NMD 120a (FIGS. 1A and 1B). The NMD 120a includes one or more voice processing components 124 and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio processing components 112g (FIG. 1C), the transducers 114, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing components 124, and only a portion of the components of the electronics 112 described above with respect to FIG. 1C. In some aspects, for example, the NMD 120a includes the processor 112a and the memory 112b (FIG. 1C), while omitting one or more other components of the electronics 112. In some embodiments, the NMD 120a includes additional components (e.g., one or more sensors, cameras, thermometers, barometers, hygrometers).

In some embodiments, an NMD can be integrated into a playback device. FIG. 1G is a block diagram of a playback device 110r comprising an NMD 120d. The playback device 110r can comprise any or all of the components of the playback device 110a and further include the microphones 115 and voice processing components 124 (FIG. 1F). The microphones 115 are configured to detect sound (i.e., acoustic waves) in the environment of the playback device 110r, which may then be provided to voice processing components 124. More specifically, each microphone 115 is configured to detect sound and convert the sound into a digital or analog signal representative of the detected sound, which can then cause the voice processing component to perform various functions based on the detected sound, as described in greater detail below. In some implementations, the microphones 115 may be arranged as an array of microphones (e.g., an array of six microphones). In some implementations the playback device 110r may include fewer than six microphones or more than six microphones. The playback device 110r optionally includes an integrated control device 130c. The control device 130c can comprise, for example, a user interface configured to receive user input (e.g., touch input, voice input) without a separate control device. In other embodiments, however, the playback device 110r receives commands from another control device (e.g., the control device 130a of FIG. 1B).

In operation, the voice-processing components 124 are generally configured to detect and process sound received via the microphones 115, identify potential voice input in the detected sound, and extract detected-sound data to enable a VAS, such as the VAS 190 (FIG. 1B), to process voice input identified in the detected-sound data. The voice processing components 124 may include one or more analog-to-digital converters, an acoustic echo canceller (“AEC”), a spatial processor (e.g., one or more multi-channel Wiener filters, one or more other filters, and/or one or more beam former components), one or more buffers (e.g., one or more circular buffers), one or more wake-word engines, one or more voice extractors, and/or one or more speech processing components (e.g., components configured to recognize a voice of a particular user or a particular set of users associated with a household), among other example voice processing components. In example implementations, the voice processing components 124 may include or otherwise take the form of one or more DSPs or one or more modules of a DSP. In this respect, certain voice processing components 124 may be configured with particular parameters (e.g., gain and/or spectral parameters) that may be modified or otherwise tuned to achieve particular functions. In some implementations, one or more of the voice processing components 124 may be a subcomponent of the processor 112a.

In some implementations, the voice-processing components 124 may detect and store a user's voice profile, which may be associated with a user account of the MPS 100. For example, voice profiles may be stored as and/or compared to variables stored in a set of command information or data table. The voice profile may include aspects of the tone of frequency of a user's voice and/or other unique aspects of the user's voice, such as those described in previously-referenced U.S. Pat. No. 10,499,146.

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The NMD 120a may use the microphone data (or transmit the microphone data to another device) for calibrating the audio characteristics of one or more playback devices 110 in the MPS 100. As another example, one or more of the playback devices 110, NMDs 120, and/or control devices 130 of the MPS 100 may transmit audio tones (e.g., ultrasonic tones, infrasonic tones) that may be detectable by the microphones 115 of other devices, and which may convey information such as a proximity and/or identity of the transmitting device, a media playback system command, etc. As yet another example, the voice processing components 124 may receive and analyze the microphone data to determine whether a voice input is present in the microphone data. The voice input can comprise, for example, an activation word followed by an utterance including a user request. As those of ordinary skill in the art will appreciate, an activation word is a word or other audio cue that signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing components 124 monitor the microphone data for an accompanying user request in the voice input. The user request may include, for example, a command to control a third-party device, such as a thermostat (e.g., NEST® thermostat), an illumination device (e.g., a PHILIPS HUE® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home.

d. Suitable Controller Devices

FIG. 1H is a partially schematic diagram of one example of the control device 130a (FIGS. 1A and 1B). As used herein, the term “control device” can be used interchangeably with “controller,” “controller device,” or “control system.” Among other features, the control device 130a is configured to receive user input related to the MPS 100 and, in response, cause one or more devices in the MPS 100 to perform an action(s) and/or an operation(s) corresponding to the user input. In the illustrated embodiment, the control device 130a comprises a smartphone (e.g., an iPhone™, an Android phone) on which media playback system controller application software is installed. In some embodiments, the control device 130a comprises, for example, a tablet (e.g., an iPad™), a computer (e.g., a laptop computer, a desktop computer), and/or another suitable device (e.g., a television, an automobile audio head unit, an IoT device). In certain embodiments, the control device 130a comprises a dedicated controller for the MPS 100. In other embodiments, as described above with respect to FIG. 1G, the control device 130a is integrated into another device in the MPS 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processor(s) 132a”), a memory 132b, software components 132c, and a network interface 132d. The processor(s) 132a can be configured to perform functions relevant to facilitating user access, control, and configuration of the MPS 100. The memory 132b can comprise data storage that can be loaded with one or more of the software components executable by the processors 132a to perform those functions. The software components 132c can comprise applications and/or other executable software configured to facilitate control of the MPS 100. The memory 132b can be configured to store, for example, the software components 132c, media playback system controller application software, and/or other data associated with the MPS 100 and the user.

The network interface 132d is configured to facilitate network communications between the control device 130a and one or more other devices in the MPS 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11g, 802.12, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 130a to one or more of the playback devices 110. The network interface 132d can also transmit and/or receive configuration changes such as, for example, adding/removing one or more playback devices 110 to/from a zone, adding/removing one or more zones to/from a zone group, forming a bonded or consolidated player, separating one or more playback devices from a bonded or consolidated player, among other changes. Additional description of zones and groups can be found below with respect to FIGS. 1J through 1N.

The user interface 133 is configured to receive user input and can facilitate control of the MPS 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone, etc.). In some embodiments, however, user interfaces of varying formats, styles, and interactive sequences may alternatively be implemented on one or more network devices to provide comparable control access to a media playback system. FIG. 1I shows two additional example user interface displays 133f and 133g of user interface 133. Additional examples are also possible.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound) and/or configured to facilitate filtering of background noise. Moreover, in certain embodiments, the control device 130a is configured to operate as playback device and an NMD. In other embodiments, however, the control device 130a omits the one or more speakers 134 and/or the one or more microphones 135. For instance, the control device 130a may comprise a device (e.g., a thermostat, an IoT device, a network device, etc.) comprising a portion of the electronics 132 and the user interface 133 (e.g., a touch screen) without any speakers or microphones.

e. Suitable Playback Device Configurations

FIGS. 1J, 1K, 1L, 1M, and 1N show example configurations of playback devices in zones and zone groups. Referring first to FIG. 1N, in one example, a single playback device may belong to a zone. For example, the playback device 110g in the Second Bedroom 101c (FIG. 1A) may belong to Zone C. In some implementations described below, multiple playback devices may be “bonded” to form a “bonded pair” which together form a single zone. For example, the playback device 110l (e.g., a left playback device) can be bonded to the playback device 110m (e.g., a right playback device) to form Zone B. Bonded playback devices may have different playback responsibilities (e.g., channel responsibilities), as will be described in more detail further below. In other implementations, multiple playback devices may be merged to form a single zone. As one example, the playback device 110a can be bonded to the playback device 110n and the NMD 120c to form Zone A. As another example, the playback device 110h (e.g., a front playback device) may be merged with the playback device 110i (e.g., a subwoofer), and the playback devices 110j and 110k (e.g., left and right surround speakers, respectively) to form a single Zone D. In yet other implementations, one or more playback zones can be merged to form a zone group (which may also be referred to herein as a merged group). As one example, the playback zones Zone A and Zone B can be merged to form Zone Group 108a. As another example, the playback zones Zone G and Zone H can be merged to form Zone Group 108b. The merged playback zones Zone G and Zone H may not be specifically assigned different playback responsibilities. That is, the merged playback zones Zone G and Zone H may, aside from playing audio content in synchrony, each play audio content as they would if they were not merged and operating as independent zones.

Each zone in the MPS 100 may be represented for control as a single user interface (UI) entity. For example, Zone A may be represented as a single entity named Master Bathroom. Zone B may be represented as a single entity named Master Bedroom. Zone C may be represented as a single entity named Second Bedroom.

In some implementations, as mentioned above playback devices that are bonded may have different playback responsibilities, such as responsibilities for certain audio channels. For example, as shown in FIG. 1J, the playback devices 110l and 110m may be bonded so as to produce or enhance a stereo effect of audio content. In this example, the playback device 110l may be configured to play a left channel audio component, while the playback device 110k may be configured to play a right channel audio component. In some implementations, such stereo bonding may be referred to as “pairing.”

Additionally, bonded playback devices may have additional and/or different respective speaker drivers. As shown in FIG. 1K, the playback device 110h named Front may be bonded with the playback device 110i named SUB. The Front device 110h can be configured to render a range of mid to high frequencies and the SUB playback device 110i can be configured to render low frequencies. When unbonded, however, the Front device 110h can be configured to render a full range of frequencies. As another example, FIG. 1L shows the Front and SUB playback devices 110h and 110i further bonded with Left and Right playback devices 110j and 110k, respectively. In some implementations, the Right and Left devices 110j and 110k can be configured to form surround or “satellite” channels of a home theater system. The bonded playback devices 110h, 110i, 110j, and 110k may form a single Zone D (FIG. 1N).

In other implementations, playback devices that are merged may not have assigned playback responsibilities and may each render the full range of audio content of which the respective playback device is capable. Nevertheless, merged devices may be represented as a single UI entity (i.e., a zone, as discussed above). For instance, the playback devices 110a and 110n in the Master Bathroom have the single UI entity of Zone A. In one embodiment, the playback devices 110a and 110n may each output the full range of audio content of which each respective playback devices 110a and 110n is capable, in synchrony.

In some embodiments, an NMD may be bonded or merged with one or more other devices so as to form a zone. As one example, the NMD 120c may be merged with the playback devices 110a and 110n to form Zone A. As another example, the NMD 120b may be bonded with the playback device 110e, which together form Zone F, named Living Room. In other embodiments, a stand-alone network microphone device may be in a zone by itself. In other embodiments, however, a stand-alone network microphone device may not be associated with a zone. Additional details regarding associating network microphone devices and playback devices as designated or default devices may be found, for example, in previously referenced U.S. Pat. No. 10,499,146.

As mentioned above, in some implementations, zones of individual, bonded, and/or merged devices may be grouped to form a zone group. For example, referring to FIG. 1N, Zone A may be grouped with Zone B to form a zone group 108a that includes the two zones, and Zone G may be grouped with Zone H to form the zone group 108b. However, other zone groupings are also possible. For example, Zone A may be grouped with one or more other Zones C-I. The Zones A-I may be grouped and ungrouped in numerous ways. For example, three, four, five, or more (e.g., all) of the Zones A-I may be grouped at any given time. When grouped, the zones of individual and/or bonded playback devices may play back audio in synchrony with one another, as described in previously referenced U.S. Pat. No. 8,234,395. Playback devices may be dynamically grouped and ungrouped to form new or different groups that synchronously play back audio content.

In various implementations, the zone groups in an environment may be named by according to a name of a zone within the group or a combination of the names of the zones within a zone group. For example, Zone Group 108b can be assigned a name such as “Dining+Kitchen”, as shown in FIG. 1N. In other implementations, a zone group may be given a unique name selected by a user.

Certain data may be stored in a memory of a playback device (e.g., the memory 112b of FIG. 1C) as one or more state variables that are periodically updated and used to describe the state of a playback zone, the playback device(s), and/or a zone group associated therewith. The memory may also include the data associated with the state of the other devices of the media system and shared from time to time among the devices so that one or more of the devices have the most recent data associated with the system.

In some embodiments, the memory may store instances of various variable types associated with the states. Variables instances may be stored with identifiers (e.g., tags) corresponding to type. For example, certain identifiers may be a first type “a1” to identify playback device(s) of a zone, a second type “b1” to identify playback device(s) that may be bonded in the zone, and a third type “c1” to identify a zone group to which the zone may belong. As a related example, identifiers associated with the Second Bedroom 101c may indicate (i) that the playback device 110g is the only playback device of the Zone C and (ii) that Zone C is not in a zone group. Identifiers associated with the Den 101d may indicate that the Den 101d is not grouped with other zones but includes bonded playback devices 110h-110k. Identifiers associated with the Dining Room 101g may indicate that the Dining Room 101g is part of the Dining+Kitchen Zone Group 108b and that devices 110d and 110b (Kitchen 101h) are grouped (FIGS. 1M, 1N). Identifiers associated with the Kitchen 101h may indicate the same or similar information by virtue of the Kitchen 101h being part of the Dining+Kitchen Zone Group 108b. Other example zone variables and identifiers are described below.

In yet another example, the MPS 100 may include variables or identifiers representing other associations of zones and zone groups, such as identifiers associated with Areas, as shown in FIG. 1N. An area may involve a cluster of zone groups and/or zones not within a zone group. For instance, FIG. 1N shows an Upper Area 109a including Zones A-D, and a Lower Area 109b including Zones E-I. In one aspect, an Area may be used to invoke a cluster of zone groups and/or zones that share one or more zones and/or zone groups of another cluster. In another aspect, this differs from a zone group, which does not share a zone with another zone group. Further examples of techniques for implementing Areas may be found, for example, in U.S. Pat. No. 10,712,997 filed Aug. 21, 2017, issued Jul. 14, 2020, and titled “Room Association Based on Name,” and U.S. Pat. No. 8,483,853, filed Sep. 11, 2007, issued Jul. 9, 2013, and titled “Controlling and manipulating groupings in a multi-zone media system.” Each of these applications is incorporated herein by reference in its entirety. In some embodiments, the MPS 100 may not implement Areas, in which case the system may not store variables associated with Areas.

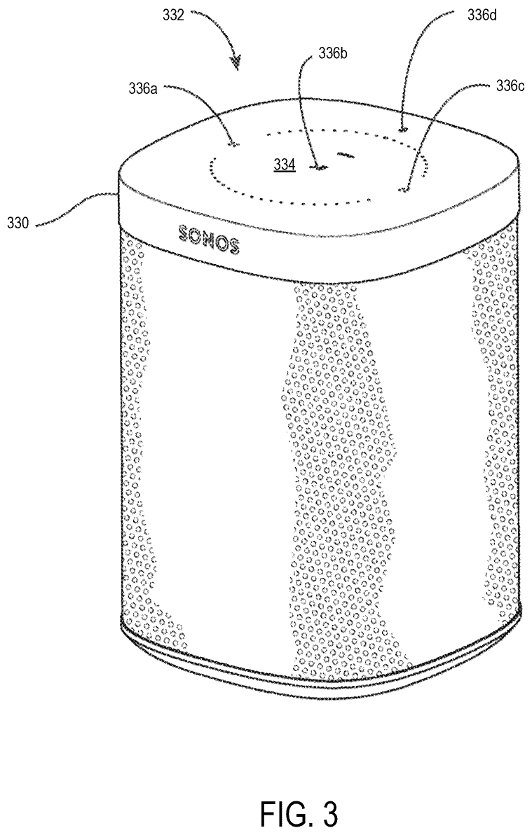

FIG. 3 shows an example housing 330 of a playback device (e.g., one of the playback devices 110 discussed above) that includes a user interface in the form of a control area 332 at a top portion 334 of the housing 330. The control area 332 includes buttons 336a, 336b, and 336c for controlling audio playback, volume level, and other functions. The control area 332 also includes a button 336d for toggling one or more microphones (not visible in FIG. 3) of the playback device 110 to either an on state or an off state. The control area 332 is at least partially surrounded by apertures formed in the top portion 334 of the housing 330 through which the microphones receive the sound in the environment of the playback device. The microphones may be arranged in various positions along and/or within the top portion 334 or other areas of the housing 330 so as to detect sound from one or more directions relative to the playback device.

f. Audio Content

Audio content may be any type of audio content now known or later developed. For example, in some embodiments, the audio content includes any one or more of: (i) streaming music or other audio obtained from a streaming media service, such as Spotify, Pandora, or other streaming media services; (ii) streaming music or other audio from a local music library, such as a music library stored on a user's laptop computer, desktop computer, smartphone, tablet, home server, or other computing device now known or later developed; (iii) audio content associated with video content, such as audio associated with a television program or movie received from any of a television, set-top box, Digital Video Recorder, Digital Video Disc player, streaming video service, or any other source of audio-visual media content now known or later developed; (iv) text-to-speech or other audible content from a voice assistant service (VAS), such as Amazon Alexa or other VAS services now known or later developed; (v) audio content from a doorbell or intercom system such as Nest, Ring, or other doorbells or intercom systems now known or later developed; and/or (vi) audio content from a telephone, video phone, video/teleconferencing system or other application configured to allow users to communicate with each other via audio and/or video.

Audio content that can be played by a playback device as described herein, including any of the aforementioned types of audio content, may also be referred to herein as media content. A source from which the media content is obtained may be referred to herein as a media content source.

In operation, a “sourcing” playback device obtains any of the aforementioned types of audio content from an audio source via an interface on the playback device, e.g., one of the sourcing playback device's network interfaces, a “line-in” analog interface, a digital audio interface, or any other interface suitable for receiving audio content in digital or analog format now known or later developed.

An audio source is any system, device, or application that generates, provides, or otherwise makes available any of the aforementioned audio content to a playback device. For example, in some embodiments, an audio source includes any one or more of a streaming media (audio, video) service, digital media server or other computing system, VAS service, television, cable set-top-box, streaming media player (e.g., AppleTV, Roku, gaming console), CD/DVD player, doorbell, intercom, telephone, tablet, or any other source of digital audio content.

A playback device that receives or otherwise obtains audio content from an audio source for playback and/or distribution to other playback devices may be referred to herein as the “sourcing” playback device, “master” playback device, or “group coordinator.” One function of the “sourcing” playback device is to process received audio content for playback and/or distribution to other playback devices. In some embodiments, the sourcing playback device transmits the processed audio content to all the playback devices that are configured to play the audio content. In some embodiments, the sourcing playback device transmits the processed audio content to a multicast network address, and all the other playback devices configured to play the audio content receive the audio content via that multicast address. In some embodiments, the sourcing playback device alternatively transmits the processed audio content to each unicast network address of each other playback device configured to play the audio content, and each of the other playback devices configured to play the audio content receive the audio content via its unicast address.

### III. Playback Device(s), Associated Housings for Device(s), and Testing Thereof

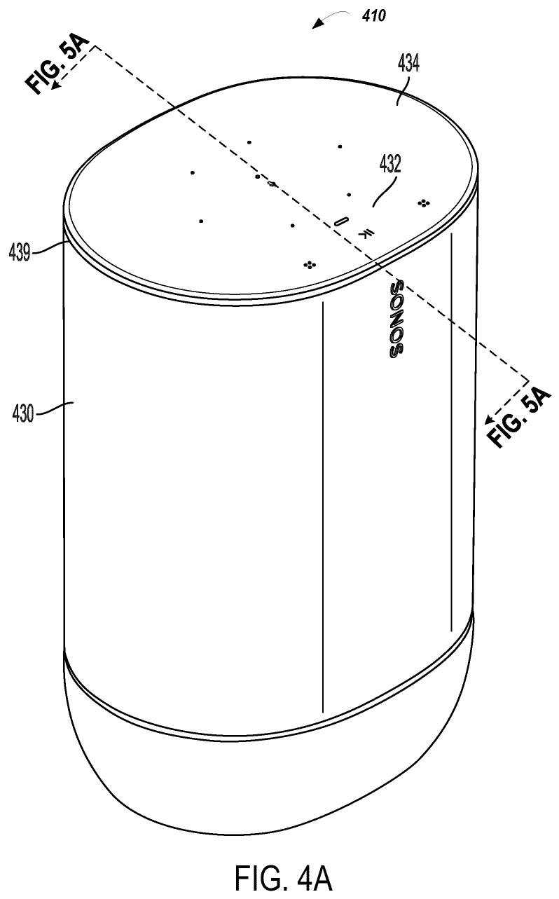

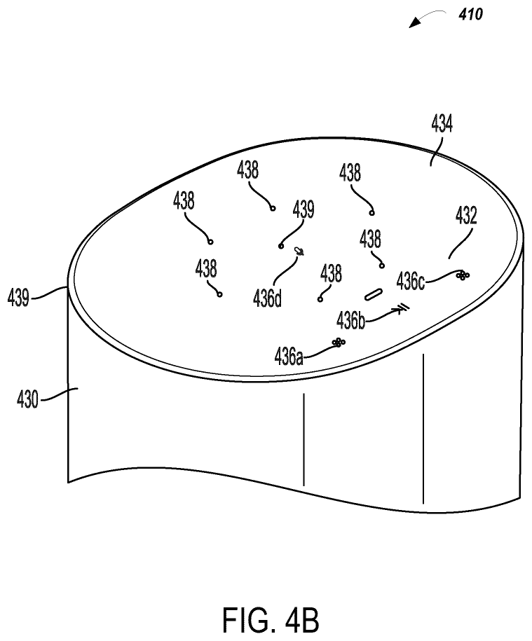

Turning now to FIGS. 4A and 4B, another example playback device 410, having a housing 430, is illustrated. FIG. 4A is a three-dimensional perspective view of the playback device 410 and FIG. 4B is a cutaway view of a top portion of the housing 430. The playback device 410 and/or housing 430 thereof may include like or similar elements to those of the housing 330, described above with reference to FIG. 3. The playback device 410 includes a control area 432, proximate to a top surface 434 of the housing 430, which may include one or more buttons 436a-c, for controlling, for example, audio playback, volume level, among other functions. A button 436d may control the on/off status of a voice assistant and/or other microphone-enabled functionality, along with an associated status light 437. The top surface 434 may further define a plurality of transducer apertures 438, each of which may be in fluid connection with one or more transducers, such as microphones (not shown), in a manner that allows for sound to reach such transducers. In some such examples, said transducers may be positioned below the transducer apertures 438 on, for example, a printed circuit board (PCB) positioned below the top surface 434 configured for aligning one or more transducers with the transducer apertures 438.

As illustrated, the top surface 434 may be a separate portion of the housing 430 that attaches to the main body of the housing 430 during manufacturing via a top surface seal 439. In this way, the top surface 434 may enclose an upper interior cavity that may provide an acoustic volume behind the microphone(s) and/or may be included as a protection cavity for electronics proximate to the upper interior cavity, such as a package for one or more microphones. In some examples, pressure leakage from this upper cavity may occur if the top surface seal 439 is inadequately formed during manufacturing or is otherwise malfunctioning. Thus, a pressure leakage at the top surface seal 439 may cause the playback device 410 to fail a pressure leakage test.

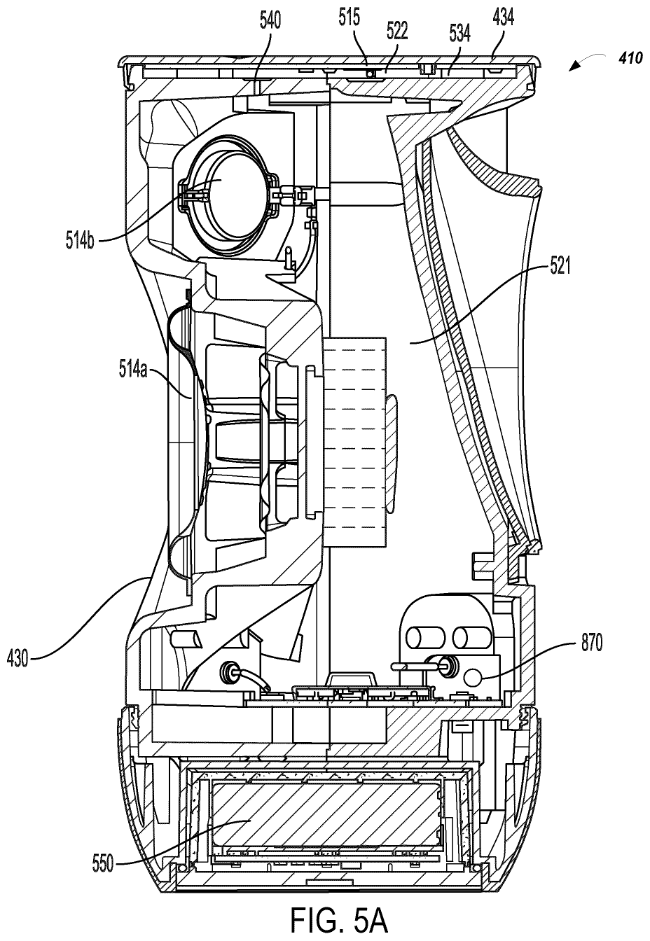

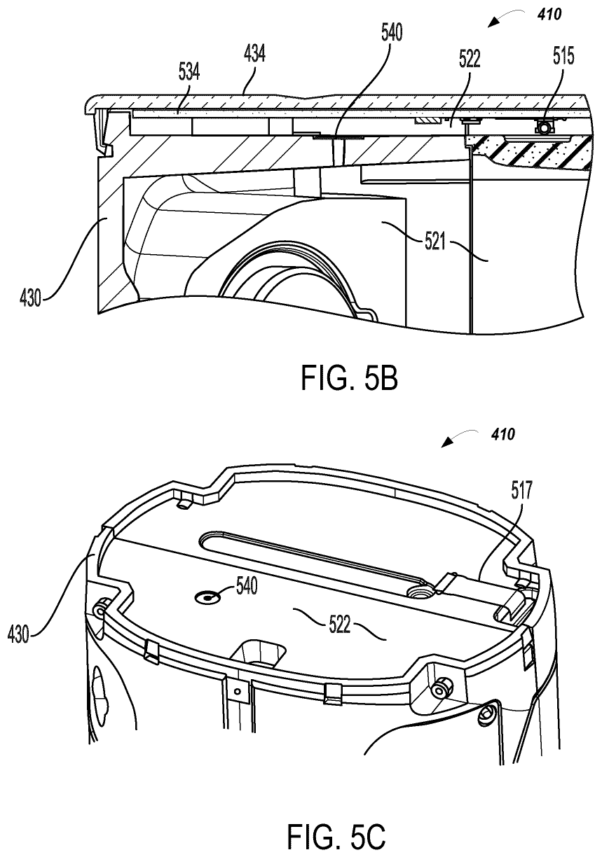

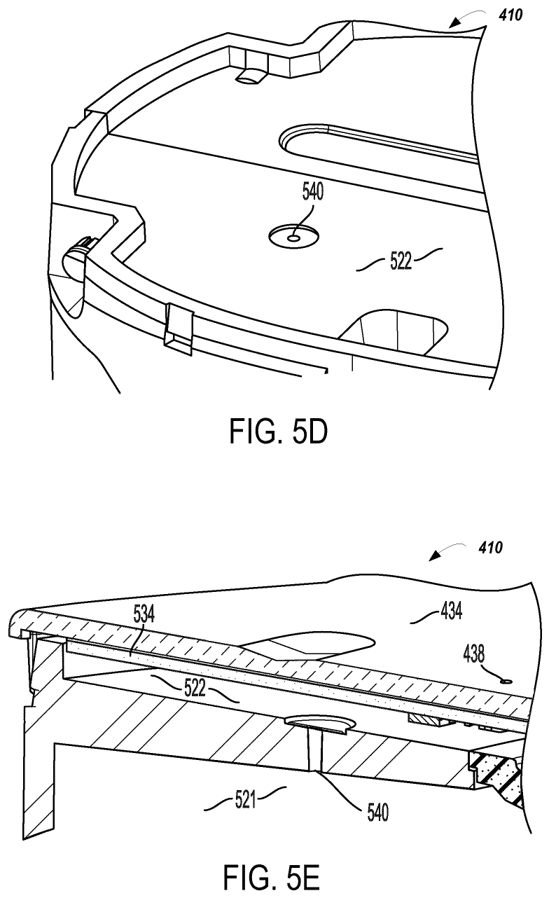

Turning now to FIGS. 5A-5E and with continued reference to FIGS. 4A and 4B, a plurality of views of the playback device 410, the housing 430, and components thereof are illustrated. Beginning with the full, cross sectional view of the playback device 410 of FIG. 5A, the playback device 410 is illustrated with a plurality of electrical components that are like or similar to those discussed above with reference to FIGS. 1-3. A callout indicating the location (e.g. a plane of view) of the cross-sectional view of FIG. 5A is illustrated in FIG. 4A with dashed lines and text indicating “FIG. 5A.”

The playback device 510 includes a plurality of audio transducers 514 (shown in FIG. 5A as a first transducer 514a (e.g., a woofer), and a second transducer 514b (e.g., a tweeter)) The audio transducer(s) 514 may include, but are not limited to including, one or more of a loudspeaker, a driver, a linear motor, a diaphragm, a tweeter, a supertweeter, a mid-range speaker, a woofer, a sub-woofer, a voice coil, a coaxial driver, a horn, or combinations thereof, among other possibilities. One or more microphones 515 may include a dynamic microphone, a condenser microphone, an electret microphone, a piezoelectric microphone, a contact microphone, a microphone pre-amplifier, a ribbon microphone, a carbon microphone, a fiber-optic microphone, a laser microphone, a microelectromechincal (MEMS) microphone, or combinations thereof. In some examples, one or more of the microphones 514b may be soldered to or otherwise affixed to a PCB 534 that is positioned proximate to the top surface 434.

In the illustrated example, the playback device 410 is portable and includes one or more energy storage devices 550 (e.g., one or more batteries). The energy storage device 550 is configured for providing electrical power to electrical components carried by the playback device 410 (e.g., one or more of the audio transducers 514, the microphones 515, the PCB 534, the one or more buttons 436, and/or other contemplated electronic components of a playback device), such as, but not limited to, additional electronic components of playback devices 110, 410, discussed above with respect to FIGS. 1-3). In some examples, the energy storage device 550 includes one or more supercapacitors or another suitable energy storage component(s). In certain examples, the energy storage device 550 includes an energy harvesting component such as, for instance, one or more solar panels. Some examples omit the energy storage device 550 altogether; in these scenarios, electrical power can be provided via a standard higher voltage power cable (e.g., a cable capable of carrying standard voltages such as 120V or 220V). In some examples, electrical power can be supplied to the device via a lower voltage power cable (e.g., a USB cable, a Power over Ethernet (POE) cable(s)).

As illustrated in FIG. 5A, the housing 430 includes or otherwise defines a first cavity 521 and a second cavity 522. The first cavity 521 has a first volume, which may be a first acoustic volume. The first cavity 521 and the first acoustic volume thereof may house at least in part, one or more of the audio transducer(s) 514 and the acoustic volume may be configured for optimizing output of the audio transducer(s) 514, for directing sound output by the audio transducer(s) 514, or for any other acoustic purpose.

The second cavity 522 has a second volume, which may be a second acoustic volume and/or may function as a protective volume, with respect to one or more electronic components. In some examples the second cavity 522 may be in fluid communication with the microphone(s) 515. Such fluid communication between the second cavity 522 and the microphone(s) 515 may mean that the microphone(s) 515 reside, at least in part, within the second cavity 522. Alternatively, in some examples, such fluid communication may not necessarily mean that the microphone(s) 515 reside within the second cavity 522, but, rather, the second cavity 522 serves as a rear acoustic volume or protective volume for the microphone(s) 515. In either example, the second cavity 522 may have the second acoustic volume configured for operations of the microphone(s) 515 (e.g., allowing for sound to resonate therein for greater capture by the microphone(s) 515). The playback device 410 may further include an input value 870 or similar port for introducing positive air pressure for a pressure leak test, as discussed in further detail below.

The second cavity 522 is illustrated in an enlarged cross-sectional view, in FIG. 5B and in a perspective view, in FIG. 5C, which illustrates the housing 430 with the top surface 434 and PCB 534 removed. To that end, the illustration of FIG. 5C shows an electrical connector 517 (e.g., a ribbon cable), which may be utilized, in manufacturing, for connecting the PCB 534 to other components of the playback device 410, prior to sealing via the top surface seal 439.

In some examples, first cavity 521 comprises a volume in the range of about 1000 cm³ to 2000 cm³ and the second cavity 522 comprises a volume in the range of about 20 cm² to 100 cm². Various other sizes and arrangements are also possible.

As illustrated in each of FIGS. 5A-5E, but best illustrated in the enlarged perspective views of FIGS. 5D and 5E, the housing 430 includes a filter, a port, or a vent 540 connecting the first cavity 521 with the second cavity 522. As discussed above, including such a vent 540 may be advantageous for providing a pressure link between the cavities 521, 522, thus simplifying and/or improving pressure testing for the playback device 410.

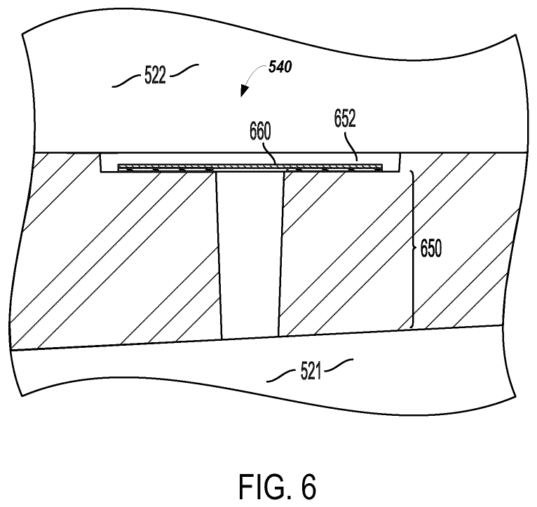

FIG. 6 is an enlarged cross-sectional cutaway view of the indicated portion of FIG. 5E. The vent 540 defines an opening, a bore, or an aperture 650 fluidly coupling the first and second cavities 521, 522. As discussed above, for instance, allowing fluid communication between the cavities 521, 522 during pressure testing can beneficially identify a leak in the second cavity based on a pressure test performed in the first cavity. The aperture 650 may include one or more diameters, such as a first diameter proximate to the first cavity 521 and a second diameter proximate to the second cavity 522. In some such examples, the aperture 650 may be frustoconical or cylindrical in shape and one or both of the first and second diameters may be in a range of about 1 mm to about 5 mm. Further, the first and second diameters may be equal or different, so long as enough fluid ingress is possible for proper pressure testing of the playback device 410 and/or the housing 430 thereof.

A receptacle or a depression 652 formed in the housing receives and at least partially surrounds an acoustic resistive mesh filter 660 and the aperture 650. As those of ordinary skill in the art will appreciate, this configuration may facilitate reliable and consistent placement of the mesh filter 660 with respect to the aperture 650 during mass production.

In some examples, the acoustic resistive mesh filter 660 is coupled with the housing 430 within the second cavity 522 via an adhesive, such as a pressure sensitive adhesive. The adhesive may affix to the acoustic resistive mesh filter 660 and may surround the aperture 650 (e.g., in a ring shape) such that the adhesive has an open area that is larger than the open area of the aperture 650. In this regard, the open area of the adhesive surrounding the aperture 650 may define the open area of the acoustic resistive mesh filter 660 that governs fluid exchange between the cavities 521, 522. In some examples, as shown in FIG. 6, the acoustic resistive mesh filter 660 is affixed to the vent 540 within the depression 652. Alternatively, the acoustic resistive mesh filter 660 may be coupled with the housing by another connection technique, such as, but not limited to, connection via heat bonding, connection via welding (e.g. ultrasonic welding), and the like.

The “acoustic resistive mesh,” of the acoustic resistive mesh filter 660, as defined herein, refers to a particular type of mesh material that is used to achieve sound attenuation or noise suppression. In the context of noise suppression internal to a playback device, the acoustic resistive mesh filter 660 may be utilized to separate the cavities 521, 522, for the sake of acoustic isolation, while allowing some fluid communication between the divided portions. An acoustic resistive mesh filter 660 may utilize such acoustic mesh materials by creating or selecting a mesh woven to a precise MKS Rayl value, which is a measure of acoustic impedance or airflow resistance. In some certain examples, the acoustic resistive mesh filter 660 may be configured to have an acoustic impedance of about 3300 MKS Rayl.

In some examples, the acoustic resistive mesh filter 660 is configured for providing, at least, 40 decibels (dB) of acoustic attenuation at a frequency of about 40 Hz. To achieve these filtering results, it may be advantageous to tune the vent 540 to form, for example, a first order low pass filter between the two cavities 521, 522, such that if any acoustic self-sound occurs it may reside outside of the human range of hearing. That said, in some examples, the acoustic resistive mesh filter 660 may be configured to operate as a low pass filter, having a −3 dB frequency of about 0.5 Hz. Thus, the acoustic resistive mesh filter 660 has a very low cutoff frequency, for low pass filtering, but still provides enough of a pressure leak path, such that the pressure leak testing can still be performed, but the acoustic resistive mesh filter 660 prevents self-sound between the two cavities. Accordingly, an acoustic resistive mesh filter 660 designed with the aforementioned low pass characteristics may result in the 40 dB of acoustic attenuation at 40 Hz, which may be a low frequency limit at which a speaker 514a in the first cavity 521 is driven.

While described as a single layer or single portion of a mesh material, the acoustic mesh filter 660 may comprise one or more mesh filters and/or one or more layers of filters. In such examples, the resistivity of multiple layers or multiple filters for embodying the acoustic mesh filter 660 may, practically, act as resistive meshes in series and, thus, the total resistivity of the multiple layers or filters of the acoustic mesh filter 660 may be a sum of the resistivity of each of the layers or filters combined.

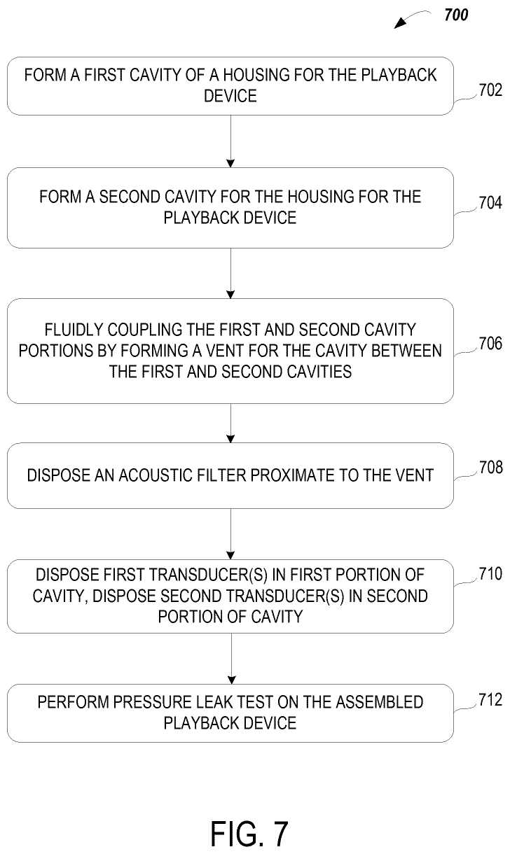

Turning now to FIG. 7 and with continued reference to, at least, FIGS. 4-6, an example flowchart is provided, illustrating operations for a method 700 of manufacturing the playback device 410. The method 700 begins at blocks 702, 704, 706, wherein the housing 430 is manufactured by forming the first cavity 521 (block 702), forming the second cavity 522 (block 704), and forming the vent 540 therebetween (block 706), thereby forming a housing 430 with fluidly coupled cavities 521, 522, via the vent 540. The method 700 further includes disposing the acoustic resistive mesh filter 660 proximate to the vent 540, as illustrated in block 708. The method 700 additionally includes disposing the transducers 514a, 514b each, respectively, in the first and second cavities 521, 522 at block 710.

To verify ingress performance, prior to distribution and/or sale of the playback device 410, the method further includes performing a pressure leak test on the assembled playback device 410 by, for example, introducing a positive pressure into the cavities 521, 522 and monitoring for any leakage, as illustrated in block 712.

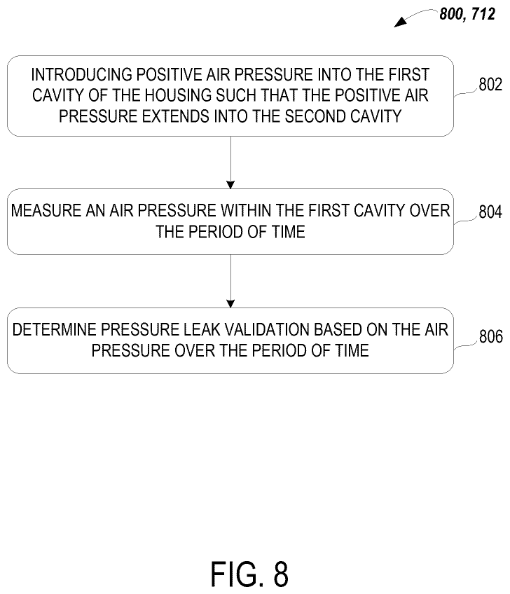

To that end, FIG. 8 is another flowchart describing a method 800 for performing a pressure leak test of the playback device 410, which may be functionally utilized as block 712 of the method 700. The pressure leak test method 800 begins at block 802, wherein the positive air pressure is introduced into the first cavity 521 of the housing over a period of time, such that the positive air pressure extends into the second cavity via the vent 540. In some such examples, the positive air pressure may be introduced via the input valve 870 associated with the first cavity 521, as shown in FIG. 5A. Then, the method 800 continues to block 804, wherein an air pressure is measured within the first cavity 521, over a period of time. Based on the pressure measured within the first cavity 521, a manufacturer of the playback device 410 can determine validation of pressure leak performance. In some examples, based on the pressure-leak test results, a manufacturer of a playback device 410 may predict if the playback device 410 will potentially pass or fail an IP rating test, such as a liquid ingress test.

### IV. CONCLUSION

The above discussions relating to playback devices, controller devices, playback zone configurations, and media content sources provide only some examples of operating environments within which functions and methods described below may be implemented. Other operating environments and configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

Further, the examples described herein may be employed in systems separate and apart from media playback systems such as any Internet of Things (IoT) system comprising an IoT device. An IoT device may be, for example, a device designed to perform one or more specific tasks (e.g., making coffee, reheating food, locking a door, providing power to another device, playing music) based on information received via a network (e.g., a WAN such as the Internet). Example IoT devices include a smart thermostat, a smart doorbell, a smart lock (e.g., a smart door lock), a smart outlet, a smart light, a smart vacuum, a smart camera, a smart television, a smart kitchen appliance (e.g., a smart oven, a smart coffee maker, a smart microwave, and a smart refrigerator), a smart home fixture (e.g., a smart faucet, a smart showerhead, smart blinds, and a smart toilet), and a smart speaker (including the network accessible and/or voice-enabled playback devices described above). These IoT systems may also comprise one or more devices that communicate with the IoT device via one or more networks such as one or more cloud servers (e.g., that communicate with the IoT device over a WAN) and/or one or more computing devices (e.g., that communicate with the IoT device over a LAN and/or a PAN). Thus, the examples described herein are not limited to media playback systems.

It should be appreciated that references to transmitting information to particular components, devices, and/or systems herein should be understood to include transmitting information (e.g., messages, requests, responses) indirectly or directly to the particular components, devices, and/or systems. Thus, the information being transmitted to the particular components, devices, and/or systems may pass through any number of intermediary components, devices, and/or systems prior to reaching its destination. For example, a control device may transmit information to a playback device by first transmitting the information to a computing system that, in turn, transmits the information to the playback device. Further, modifications may be made to the information by the intermediary components, devices, and/or systems. For example, intermediary components, devices, and/or systems may modify a portion of the information, reformat the information, and/or incorporate additional information.

Similarly, references to receiving information from particular components, devices, and/or systems herein should be understood to include receiving information (e.g., messages, requests, responses) indirectly or directly from the particular components, devices, and/or systems. Thus, the information being received from the particular components, devices, and/or systems may pass through any number of intermediary components, devices, and/or systems prior to being received. For example, a control device may receive information from a playback device indirectly by receiving information from a cloud server that originated from the playback device. Further, modifications may be made to the information by the intermediary components, devices, and/or systems. For example, intermediary components, devices, and/or systems may modify a portion of the information, reformat the information, and/or incorporate additional information.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

1. A playback device comprising:
at least one first transducer;
at least one second transducer;
a housing comprising:
a first cavity having a first volume, the first cavity housing the at least one first transducer;
a second cavity having a second volume, the second cavity in fluid communication with the at least one second transducer; and
a vent fluidly coupling the first cavity and the second cavity, the vent defining an aperture having an open area; and
an acoustic resistive mesh filter coupled to the vent and positioned to cover the open area of the aperture and thereby resist acoustic flow through the vent.

2. The playback device of claim 1, wherein the at least one first transducer comprises a loudspeaker, and wherein the at least one second transducer comprises a microphone.

3. The playback device of claim 1, wherein the aperture is circular and comprises a diameter in a range of about 1 millimeter (mm) to about 5 mm.

4. The playback device of claim 1, wherein the acoustic resistive mesh filter is configured for providing at least 40 decibels (dB) of acoustic attenuation at a frequency of 40 hertz (Hz).

5. The playback device of claim 1, wherein the acoustic resistive mesh filter has a specific acoustic impedance of about 3300 MKS Rayls.

6. The playback device of claim 1, wherein the housing is configured for a liquid ingress protection (IP) code of, at least, IPX6.

7. The playback device of claim 1, wherein the acoustic resistive mesh filter is coupled to the housing within the second cavity via an adhesive.

8. The playback device of claim 7, wherein the adhesive comprises an open area that is larger than the open area of the aperture such that the adhesive surrounds the aperture.

9. The playback device of claim 1, wherein the second cavity of the housing comprises a depression surrounding the aperture, and wherein the acoustic resistive mesh filter is positioned within the depression.

10. The playback device of claim 1, wherein the first cavity comprises a volume in the range of about 1000 cm³ to 2000 cm³, and wherein the second cavity comprises a volume in the range of about 20 cm² to 100 cm².

11. The playback device of claim 1, wherein the first cavity comprises an input valve for receiving an applied air pressure to the first cavity.

12. The playback device of claim 1, wherein the playback device is a portable playback device and further comprises a battery contained within the housing.

13. A method of performing a pressure leak test of a playback device, the playback device comprising:
at least one first transducer;
at least one second transducer;
a housing comprising:
a first cavity having a first volume, the first cavity housing the at least one first transducer;
a second cavity having a second volume, the second cavity in fluid communication with the at least one second transducer; and
a vent fluidly coupling the first cavity and the second cavity, the vent defining an aperture having an open area; and
an acoustic resistive mesh filter coupled to the vent and positioned to cover the open area of the aperture and thereby resist acoustic flow through the vent;
the method comprising:
introducing, via an input valve of the first cavity, a positive air pressure into the first cavity of the housing over a period of time such that the positive air pressure extends into the second cavity via the vent; and
measuring an air pressure within the first cavity over the period of time.

14. The method of claim 13, further comprising, based on the air pressure within the first cavity over the period of time, determining an indication of one of a passing liquid ingress test or a failing liquid ingress test.

15. The method of claim 13, further comprising determining estimated liquid ingress performance, based on the air pressure within the first cavity over the period of time.

16. The method of claim 13, wherein the at least one first transducer comprises a loudspeaker, and wherein the at least one second transducer comprises a microphone.

17. The method of claim 13, wherein the aperture is circular and comprises a diameter in a range of about 1 millimeter (mm) to about 5 mm.

18. The method of claim 13, wherein the acoustic resistive mesh filter is configured for providing at least 40 decibels (dB) of acoustic attenuation at a frequency of 40 hertz (Hz).

19. The method of claim 13, wherein the acoustic resistive mesh filter has a specific acoustic impedance between about 3300 MKS Rayls.

20. The method of claim 13, wherein the acoustic resistive mesh filter is coupled to the housing within the second cavity via an adhesive.
